(19) United States
(12) Patent Application Publication
(10) Pub. No.: US 2009/0292597 A1
(43) Pub. Date: Nov. 26, 2009

(54) Parking payment and enforcement mechanism

(76) Inventors: Roy Schwartz, Mountain Lakes, NJ (US); Zarick Schwartz, Mountain Lakes, NJ (US)

Correspondence Address: Kristina Peckins, 562 Kensico ct., Suffern, NY, 10901, US

(21) Appl. No.: 12/469,678

(22) Filed: May 20, 2009

Related U.S. Application Data
(63) Continuation-in-part of application No. 61/054,808, filed on May 20, 2008.

(51) Int. Cl. G06Q 50/00; G06Q 10/00; G06Q 20/00; G01C 21/00

(52) U.S. Cl. 705/13; 705/30; 705/40; 701/300

(57) ABSTRACT

This application describes a means of paying for metered parking using the cell phone. It uses information from telecommunications systems to identify the region of the origin of the caller and the caller's parking location. Further input is used during the call to narrow the region to the specific city and the parking rate to be charged. This method saves the user from entering different phone numbers for different town and fewer digits than the alternative of numbering individual meters. Furthermore, it saves the towns from numbering all their meters as proposed by existing methods. It also describes improved methods for enforcements.

### BACKGROUND

1. Field of the Invention

This invention relates to methods for payments and enforcement of metered parking where payments are made remotely by a parker's device.

2. Description of Related Art

Paying for metered parking is a big hassle. People often do not have change available and have to go looking for change or take a risk parking without feeding the meters. Also, if they overstay their ‘paid’ time, they may have to rush back and reefed the meter.

Parking meters come either as single pole meters or multi-meters. Single pole meters accept coins and show remaining time for a single parking spot. Multi-meters control many parking spots (e.g. 10) and all parkers come to the specific meter to enter money and, in the most common deployment, receive a receipt that they have to display on their dashboard.

Towns and cities have tried to alleviate some of the hassle by introducing pre-paid cards, however, this helps only if somebody has bought the pre-paid card ahead of time. Furthermore, a pre-paid card for one city is not usable in another town or city.

Another solution some cities are trying is to have meters accept credit cards. This is more usable across various towns, but it is costly to upgrade meters to accept credit cards both because the meters are more expensive and they need a wireless connection to some central location to validate the credit cards. Also this solution still requires the parker to walk to the meters even if his destination is in the opposite directions.

Some towns and cities are trying cellular phone based payment mechanism that are potentially more flexible and usable. In this solution, each spot in the town is numbered (e.g. using 5 to 6 digits) either on the ground or with a label on the single pole meter. FIG. 1 illustrates this solution where the user first registers for this service by placing a call in step 1 and providing relevant information including license plate and credit card information to a remote administration server in step 2.

After parking the car, the parker reads the displayed meter number in step 3 and places a call to a phone number, specific to the town, in step 4. The parker is prompted by the RAS to enter the meter number in step 5. Based on the entered meter number the RAS knows the parking rate (e.g. $1/hr) to charge in step 6. When the parker has finished parking and is about to leave, the parker calls the town specific phone number again in step 7. Knowing the time parked and the rate of parking, the RAS determines the proper charge and charges the parker's account in step 8.

The drawback of this scheme is that the parker has to 1) remember a town specific phone number to dial since each town will have its own numbers or else the number of metered space would be larger. 2) Parker has to read 5 to 6 digits meter number which may be hard and require walking close to the sign. 3) Parker has to enter 5 or 6 digit meter number in to the cell phone. 4) The towns have to number all the metered space which makes trying out the system across a town very difficult due to the overhead involved. 5) Some cities or towns which have multi-meters do not have clearly marked spots so that more cars can be parked in a given area. They cannot use this solution since they cannot number their distinct spots because there are no distinct spots.

Another aspect of metered parking payment by cell phone is the mechanism of enforcement. Currently, the enforcers enter license plate or meter numbers into a handheld device to check if the vehicle has paid for parking. This is illustrated in FIG. 2. The enforcer carries a portable handheld terminal which wirelessly communicates with the RAS. The enforcer, in step 1, enters the meter number and also possibly the license plate of the parked vehicle to determine if the vehicle has paid for parking. The RAS determines if that parking spot has been paid for in step 2 and returns the result in step 3 which is displayed to the enforcer. This enforcement mechanism can be cumbersome and time consuming for the enforcer.

### SUMMARY

Our solution does not have the above drawbacks to the parkers or the towns. Furthermore, we show how enforcement can be dramatically improved. Our novel solution does not require labeling each meter spot. Instead, in one embodiment, we first identify one of the predetermined regions a parker is calling from by using location information that we extract about the call from the telecommunications system. Within each region we identify each town and within each town, the rate charged per hour by a unique two digit TARI (town and rate identifier) number entered by the parker. For identifying the region, we can use SS7 or other location determining methods.

We also describe another embodiment where a call is not placed via phone, but an application on the phone sends a data message to the parking service indicating its desire for parking and also determines and sends the location of parking. The parking location of the parker is identified by using GPS or other location system available on the phone. However, this location value may have an error, hence, the parker may need to add a TARI digit by reading the TARI number displayed in the parking zone, as in our previous embodiment.

In another embodiment, the parker's device automatically determines that the vehicle is parked and determines the location and sends it to the parking service servers for parking payment.

We also improve how enforcement is performed. In one embodiment, the enforcer wears a camera on his persons (e.g. on the hat or shoulder) which is constantly taking images of the parked vehicles. The images are analyzed by the camera or the enforcer's device to recognize the license plate number which is sent to parking service servers to determine if that vehicle has made parking payment. In another embodiment, the enforcer speaks the license plate number and the enforcer's device performs speech recognition. The resulting license plate is sent to parking service servers to determine if the vehicle has made payment.

In another embodiment, if precise location determination capability is available at the enforcer's device and at the parker's device (when the car was parked) then we use the precise location information to identify the parked car and whether that car has made parking payments.

### BRIEF DESCRIPTION OF THE DRAWINGS

FIG. 1 illustrates the existing parking meter payment by cell phone method.

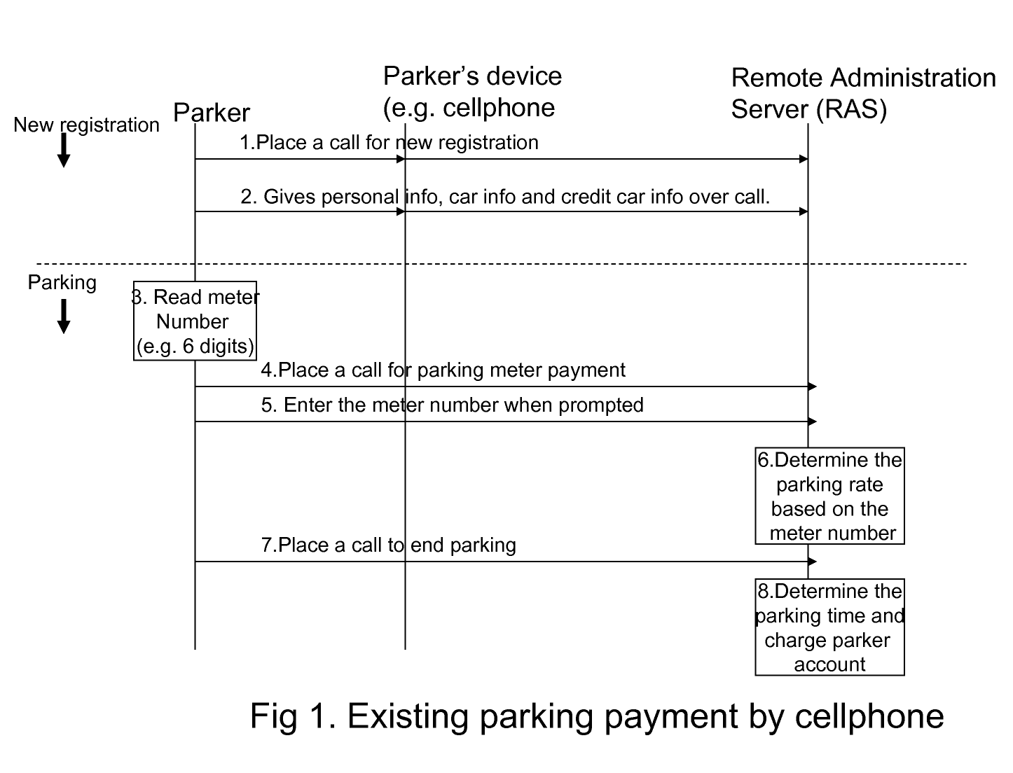

FIG. 2 illustrates the enforcement method associated with the payment method of FIG. 1.

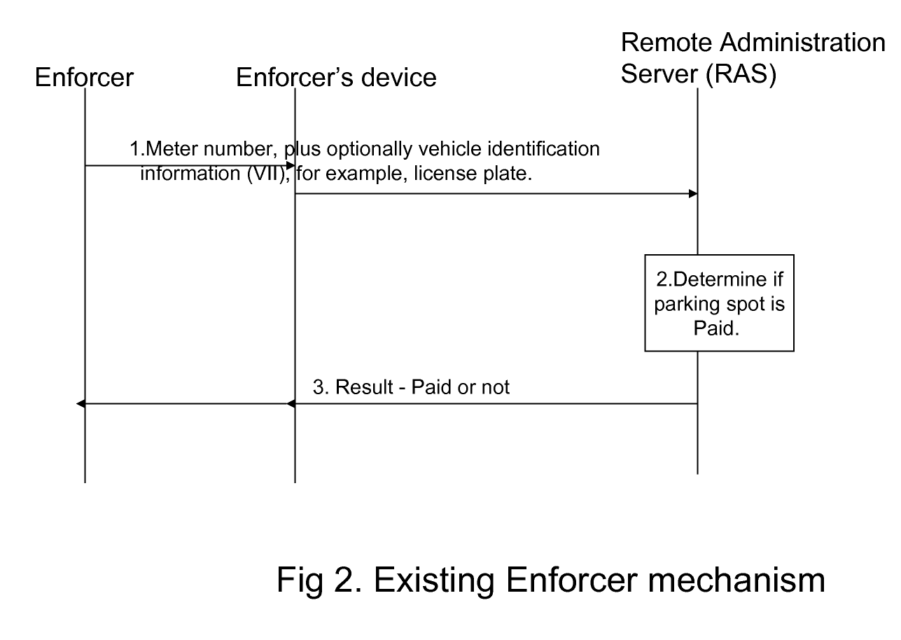

FIG. 3 illustrates the parking meter payment method using SS7 and entering a “town and rate identifier” (TARI) in one embodiment of the invention.

FIG. 4 illustrates the parking meter payment method using GPS and entering a TARI in one embodiment of the invention.

FIG. 5 illustrates a method for TARI assignment to uniquely identify a rate when GPS is used for determining parking location region (i.e. the method of FIG. 4)

FIG. 6 illustrates a method for a parker's device to automatically pay for metered parking.

FIG. 7 illustrates an enforcement method using a camera.

FIG. 8 illustrates an enforcement method where the enforcer speaks the license plate number.

FIG. 9 illustrates an enforcement method using precise location information determination both by the enforcer device and by the parker's device.

### DETAILED DESCRIPTION OF THE INVENTION

Using Location Determination to a Region

In the following, a parker's device may be a portable device with communication capability like a cellphone or a fixed device inside the car. Each device has a unique Id, called the parker's device Id, for example the phone number for a cell phone. A parker account is also created during registration that stores information about the user, payment method, and the vehicle information (e.g. license plate). The payment method can include credit card, debit card, pre-paid, etc. Each town defines rates for parking in different areas (rate areas), for example down town may have one rate ($1/hr) whereas the rest of the town may charge another rate ($0.50/hr).

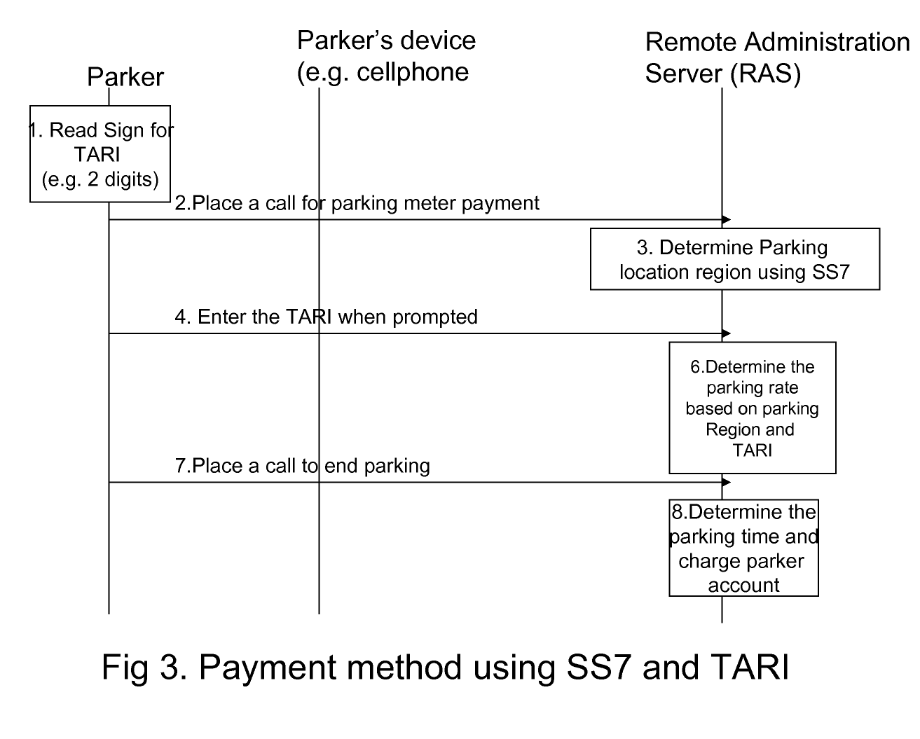

In one embodiment, illustrated in FIG. 3, we first identify the region a parker is calling from by using location information that we extract about the call from the telecommunications system. This region may be large enough to encompass many different rate areas of a town or many towns and cities (e.g. size of a county or many counties). Within each region we identify each town and within each town, the rate charged per hour by a unique two digit TARI (Town and Rate Identifier) number (In some rare cases, more digits can be used if needed). Thus a TARI number serves two functions, one is to identify the town within a region and then identify a rate charged within a town. The two digit number is posted on the meter or on a sign post used for posting parking rules. It is important that the TARI is not repeated within the region. TARI is also referred to as rate identifier in the claims.

The parker in step 1 of FIG. 3, reads the TARI number without walking from the car because the two digit, which apply for many spots or the whole block, can be written in a large font and should be visible from a distance. The parker, in step 2, places a call to a well known phone number, which can be same for many towns or same even for all towns across the country. The parking services servers, called Remote Administration Server (RAS), uses SS7 signaling to determine the switching region from which the parker is calling from. The MSC (or mobile switching center) serve a large, but predefined region and the terminating SS7 endpoints in the RAS can know the SS7 originating point code (OPC) of the MSC through which the cell phone call originated. Jurisdiction Information Parameter (JIP) can also be used to help determine the parked region either alone or in combination with the OPC. Thus the RAS can know the region of the parker without the parker having to enter any information yet. However, the region is large enough that it may encompass many towns and there may be many rates within even one town (e.g. most of the town charges $0.50/hr whereas downtown charges $1/hr for metered parking).

In order to further narrow the location of the parker to the point that a unique parking rate and a parking authority can be determined, the RAS prompts the parker to enter the TARI number via IVR. The parker enters this in step 4. The typically two digit TARI number is much more convenient to read and enter than the 5 or 6 digit meter number. The RAS now has enough information to uniquely determine, in step 6, which town the vehicle is parked and what parking rate to charge. The RAS creates a record associating the parker's device ID or account with a paid indication. Although we talk about towns having metered parking through out the specification, it should be understood that this merely for ease in exposition and other entities like States, Universities, Park-and-ride facilities, Airports, etc can also offer metered parking. Also, although we mention two digits for TARI, the amount of digits are determined by the number of town or parking providers and the number of rates in the region.

When the parker has finished parking and is about to leave the parked spot, the parker places a call to the parking service in step 7 which lets the RAS know that the parker is no longer parked and wants to stop paying for parking. In step 8, the RAS knowing the parked time and the rate determines the amount to charge for metered parking and charges the parker's account. The RAS deletes the association of the parker's device ID or account with a paid indication. Other obvious variations are possible to the above, for example, the parker could have provided the amount of parking time desired in step 4 rather than calling back to indicate the end of his parking. Also instead of placing a call used to convey TARI and other information, other means of data communications (e.g. tcp, http) can be used, so long as the communication allows us to determine the location to a fixed region. Also instead of a cell phone, other user device could be used for this purposes, including PDAs, or GPS units in the vehicle. Also instead of the RAS determining the parker location to the fixed region, the parker's device could have determined the location and conveyed to the RAS.

One advantage of our invention to the towns is that they do not need to number their meters, and they can use multi-meters that work without distinctly marked parking spots. This saves a lot of expense and overhead for the town since the towns only need to post TARI number stickers.

A parker new to the service can call the number and would be prompted to register with the service by providing the cell phone number, credit card number and the car's information, including the license plate.

Note that although we describe the present embodiment with respect to SS7, any other technology that allows the determination of the caller's location to a fixed region can be used. Also various alternatives are possible as to when TARI is entered and sent. For example, instead of one number, we can have 100 telephone numbers, one for each TARI number. So that when the user dials the number, the RAS knows which TARI is indicated without requiring the user to enter another two digits.

Determining Location with an Upper Bound Error

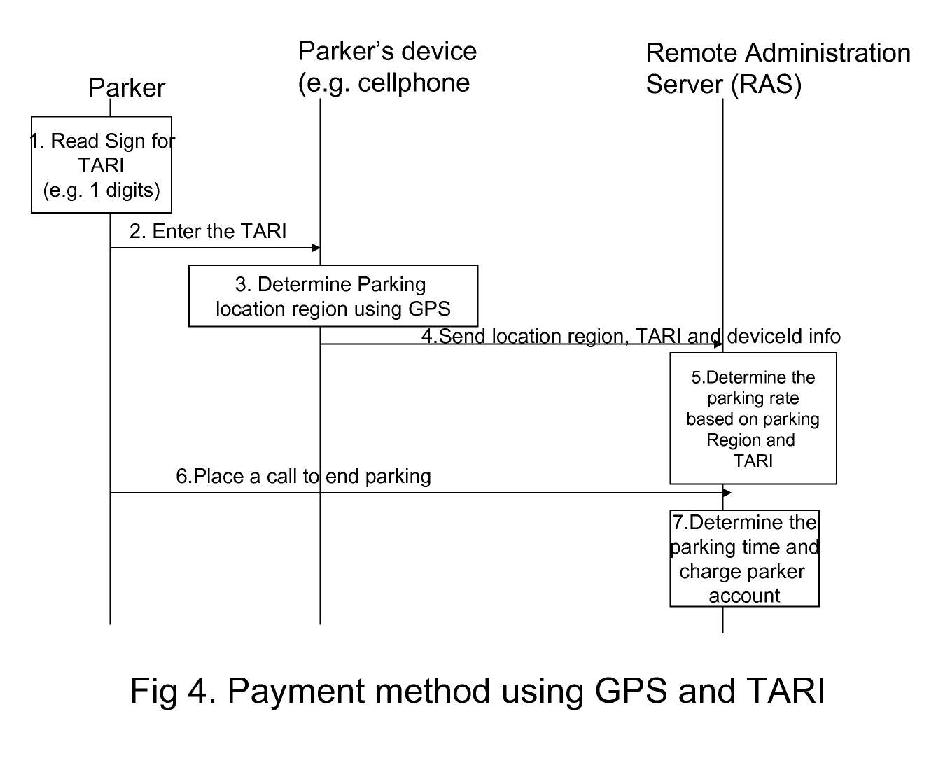

In another embodiment, the parker enters the TARI number into a device and requests payment for parking. The parker's device uses GPS to determine its location (with some error bound) and sends the device's id number, the GPS determined location and TARI to the RAS. This is illustrated in the FIG. 4 where the parker reads the TARI number from the street sign in step 1 and requests parking payment by entering the TARI number in the parker's device in step 2. The parker's device uses GPS to determine its current location; the latitude and longitude determined by the GPS has enough significant digits to pin point the parking spot of the car, unfortunately, consumer GPS device often have sufficient errors that they are not sufficient to determine the rate within a town or sometimes even which town the vehicle is parked in.

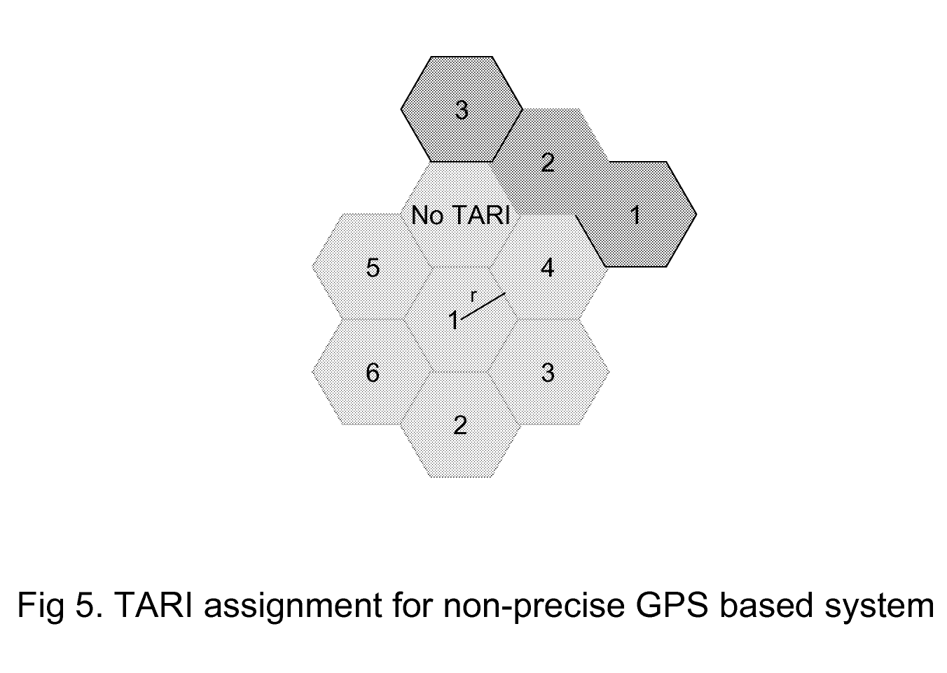

In step 4, the device sends the device ID or user's account ID for charging purposes, along with the determined location information and the entered TARI. The RAS determines the parked town and the rate to charge in step 5. This is possible because of the method we use to allocate TARI (described in FIG. 5) and the fact that although the GPS devices have an error, we can appropriately set an upper bound for the error (e.g. 200 meters, we will use this value discussion purposes below). We have to make sure that a TARI number is not repeated in any neighboring regions and additionally any non-neighboring region that repeats the TARI number is at least 400 meters (i.e. twice the upper error bound distance) away (more about this below). In step 6, the parker informs RAS of the end of parking and in step 7, the RAS determines the time parked, the amount to charge, and charges the parker's account.

Although we describe the present embodiment in terms of GPS and the parker's device determining the location (with some error bound), it may be appreciated that other location determining technologies can be used and instead of the parker's device, the network or the RAS can determine the location (with some error bound). The various position determining technologies include, but not limited to, Global Positioning System (GPS), assisted GPS, triangulation at the base station, information from SS7 networks, and Location Based Services (LBS).

FIG. 5 illustrates a method for allocating TARI numbers such that typically only a single TARI digit is used and we can still uniquely determine the town and rate to charge. First let us illustrate the problem with location determination that have errors. If two neighboring towns have parking close to their border then if they both reuse the same TARI number without co-ordination then the RAS would not be able to determine which town the vehicle is parked in because the errors in GPS would not allow us with confidence to say which town the vehicle is parked in.

What if the town borders were separated with an area without parking with a radius of 200 meters? This is still not enough because if a vehicle is parked near the border of the first town, the reported location may be in the no parking region but closer to the border of the second town and would be mistaken to be parked in the second town. However, if the no parking region between the towns was twice the maximum error distance of GPS units (i.e. 400 meters based on the 200 meter upper bound error of GPS we have been using for discussion purposes so far) then we can uniquely determine the parked town because even with the addition of the error distance, a car parked at the border of the first town will report location that is closer to the first town rather than second town.

Instead of relying on “no parking regions” we can use regions with different TARI numbers for separating regions with the same TARI number and still uniquely determine the town. Also, the same method can be used for assigning TARI numbers for determining different parking rate regions within a town. FIG. 5 illustrates an embodiment of the method for TARI assignment. The blue cell numbered 1 is surrounded by cells that do not have TARI number 1 and the smallest radius (distance from the center to the nearest point on the border) is r. In our example number, we would set r to be 200 meters. TARI number 1 is repeated in the green cell which is at least 2 r or 400 meters away and is separated by the blue cell with TARI number 4. Similarly, all the cells neighboring blue cell 1 are either numbered with a different TARI number or are non-parking cells and have no TARI number.

In another embodiment we can get rid of the need for entering TARI or minimize the need to enter TARI by using some pre-planning of the rate areas. If the towns plan their rate-areas such that there is “no parking regions” separating the rate areas then there is no need to ask the user to enter TARI;, the location information (even with errors) is accurate enough to determine the rate area. Instead of eliminating the need to enter TARI, we can also choose to ask the user to enter TARI only when we are unsure of the rate region. If the user is parked in a rate area that is surrounded with a “no parking region” or if the rate area is large and contiguous and the reported location is away from the border of the rate area then we do not have to ask the user for entering TARI, otherwise we can prompt the user to enter TARI. Also knowing which type of vehicle the parker has (e.g. commercial, personal) will also allow us to determine the applicable rate areas.

Many different variations are possible based on the above embodiments.

Automatic Payment

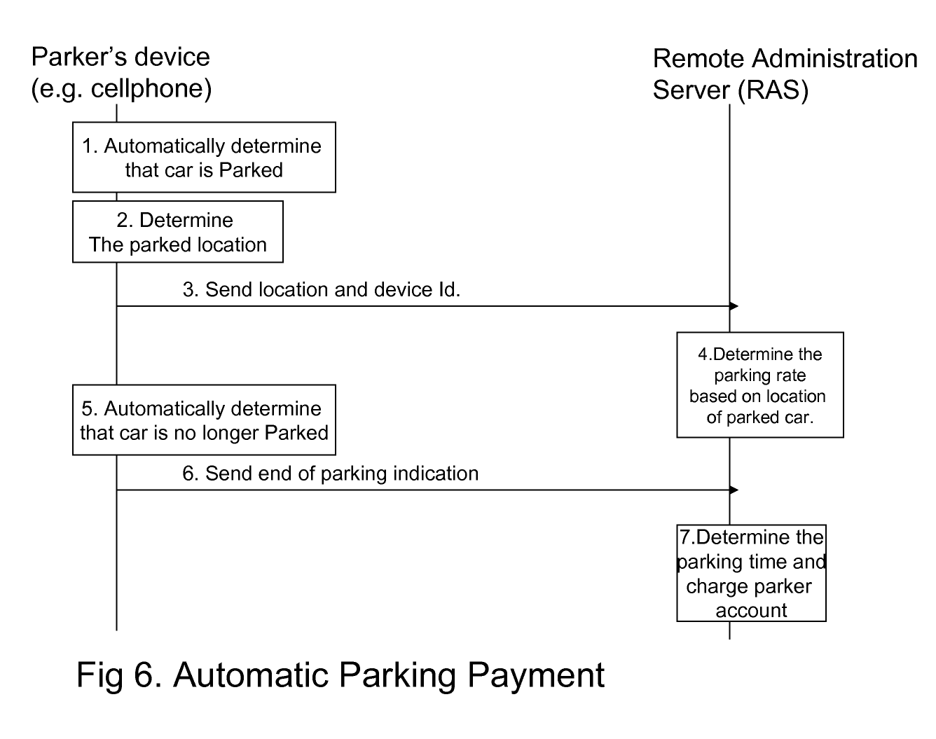

In another embodiment, the parker's device automatically determines that the vehicle is parked and determines the location and sends it to central location for parking payment. This is illustrated in FIG. 6. When the vehicle stops and parks, the parker's device automatically determines that the car is parked in step 1. This can be done by first detecting that the car is stopped for some period of time using various methods, including GPS velocity detection, vibrational measurement techniques [?] and indication from the vehicles itself. The vehicle determines the parked location (e.g. using GPS) in step 2 and sends the device id or account id and the location information to the RAS in step 3, transparently to the parker.

In step 4, the RAS may perform the additional step to determines if this is an acceptable parking location based on its database of parking location, and will charge only if it is an acceptable location.

The parker's device needs to have a location determining system that has small enough error so that two different rate regions (e.g. two blocks) are separated by a distance that is greater than twice the maximum error of the location system in the parker's device. The location determination of the parked car can be improved by taking multiple measurements over the parked duration of the car. Another alternative is for the towns to either have one rate for the town or to make sure that the different rates are separated more than twice the maximum error distance of the location determining units.

In step 5, when the vehicle moves, the parker's device determines that the car is no longer parked using various techniques, including GPS based velocity detection, vibrational techniques, or signals from the vehicle itself. In step 6, the parker's device sends an end of parking indication to the RAS. In step 7, the RAS determines the overall parking time and calculates the amount to charge, and charges that amount to the user's account.

The parker's device can be a portable device or a fixed device in the vehicle.

Enforcement

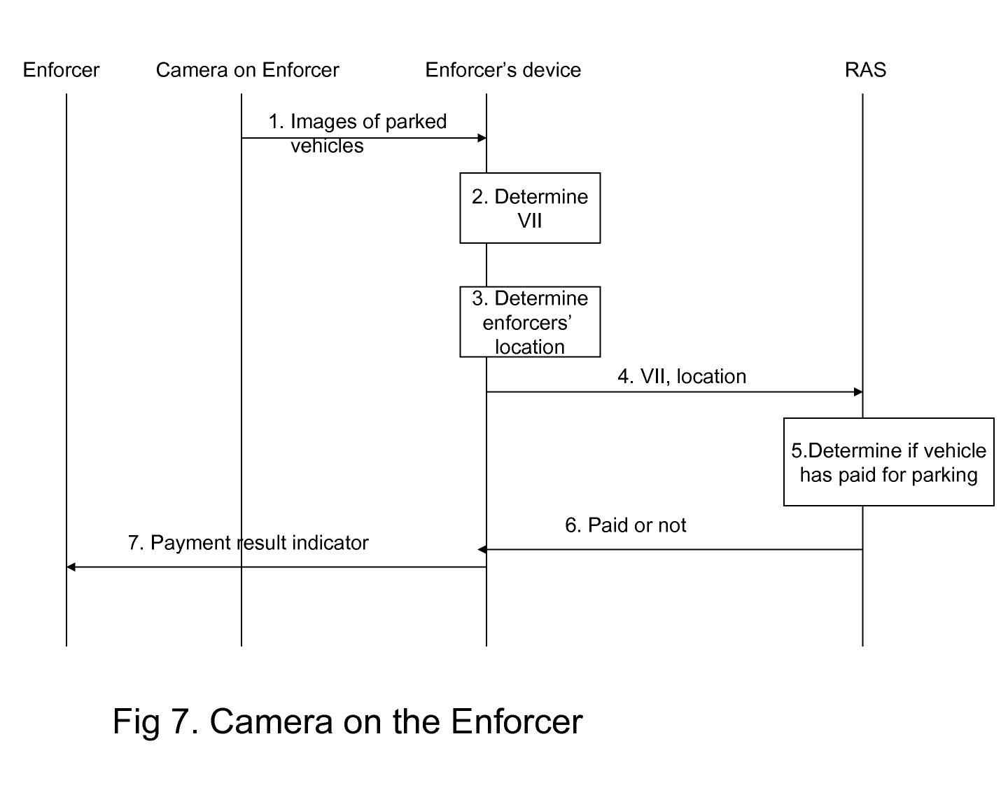

We also improve how enforcement is performed when parking payment by cellphone's or other device is performed. In one embodiment, the enforcer wears a camera on his persons (e.g. on the hat or shoulder) which is constantly taking images of the parked vehicles. FIG. 7 illustrates this where the enforcer wears a camera and carries a device (“enforcer's device). The enforcer walks his beat wearing the camera and pointing it towards the parked car. In step 1, the camera takes multiple images or video of the parked vehicles and their license plates and sends them to the enforcer's device. In step 2, the enforcer's device determines the license plate number (i.e. the vehicle identification number or VII). In step 3, the enforcer's device also determines the enforcer's location, accurate enough to determine the parking rate to be charged for the town. Alternatively, the enforcer could have entered this rate information manually. Knowing where the enforcer is can also aid in license plate number recognition because license plates of cars not near the current location can be ruled out as possible results.

In step 4, the enforcer's device sends the location information of the enforcer and the VII of the car determined in step 2 to the RAS. The RAS, in step 5, determines if the vehicle with the VII has paid for parking with the correct rate by comparing the VII with the vehicle signature, which is the license plate in this embodiment, which was received at registration and checking the paid status of the account with the vehicle signature. Also previously when the parker's device had contacted the RAS, at the start of parking, a record was created associating the parker's Id/account and the vehicle signature and the paid status. In step 6, the RAS returns the result, whether parker has paid or not, to the enforcer's device. The enforcer's device, in step 7, displays or announces the result to the enforcer. This continues automatically, for each vehicle that the enforcer passes. The enforcer may wear an headphone to hear the announcement. The record associating the parker's id or vehicle signature with the paid status is deleted after the parking ends.

Other variations are possible for the above embodiment, for example, whether the image processing is done in the camera or the enforcer's device, or in a device in the enforcer's car or if they are sent to a server in the network for processing. Also the enforcer could be walking or riding a bike. Also, instead of RAS determining if the vehicle has paid for parking, the enforcer's device could have pre-fetched a list of paid parker's from the RAS ahead of time (e.g. every 30 seconds) and perform step 5 in the enforcer's device. The pre-fetched list could be a subset of the vehicles that have paid for parking where the subset is proper and could be the entire group. The subset could be less than the whole group based on the current location of the enforcer. The vehicle signature in general represents at least one characteristic of the car that helps identify it; it could be the license plate or a distinguishable image of the car or accurate location information of the car which allows us to associate the parker's car with the location.

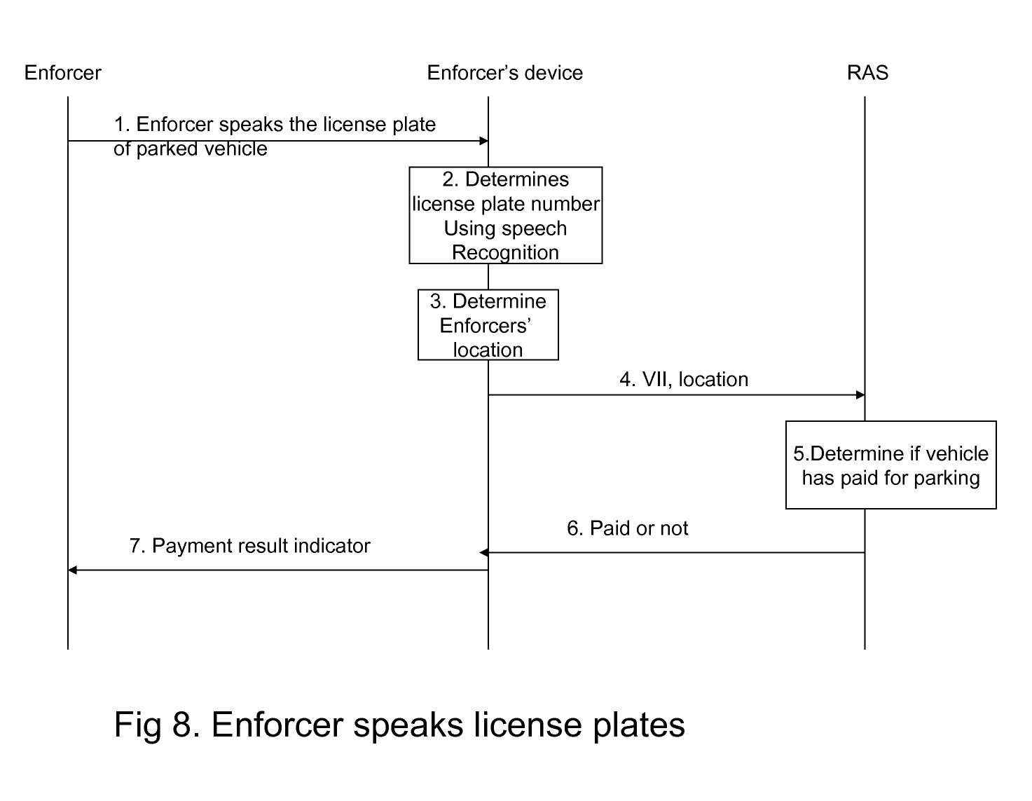

In another embodiment, illustrated in FIG. 8, the enforcer speaks the license plate numbers of the parked vehicle into a microphone in step 1. The enforcer's device determines the plate number using speech recognition in step 2 and it also determines the enforcer's location in step 3. The rest of the steps are similar to the previous embodiment.

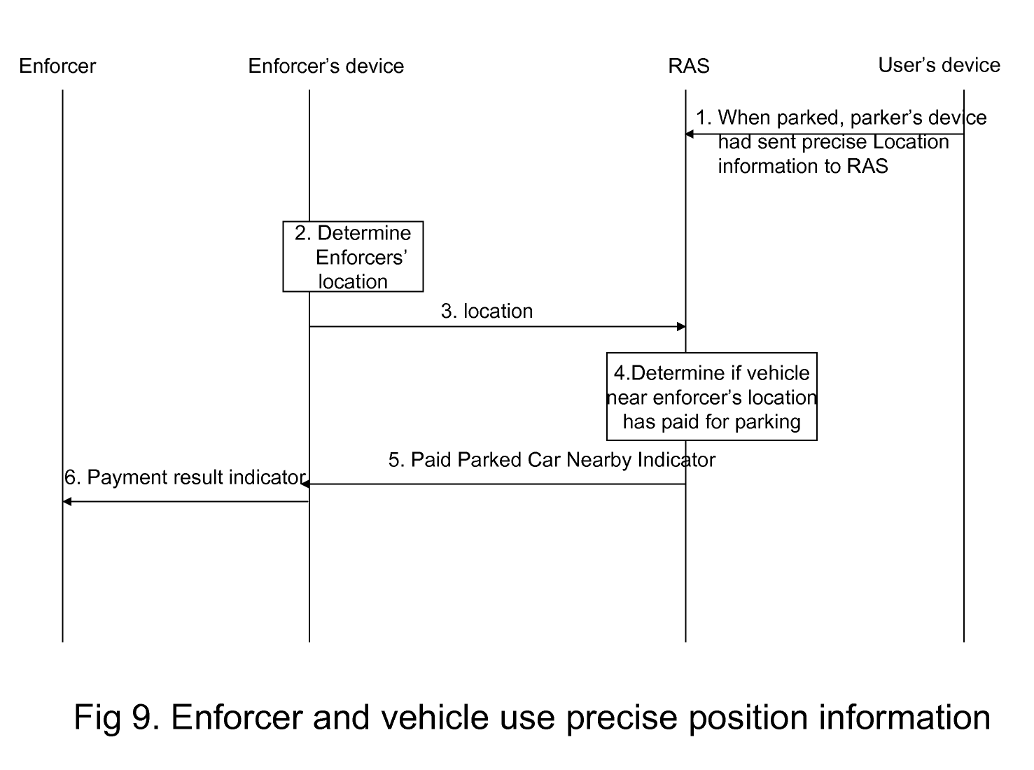

In another embodiment, illustrated in FIG. 9, the parker's device can determine the precise location of the vehicle, accurate to the parking spot and had sent this vehicle signature information to the RAS in step 1. Later on, the enforcer, while walking his beat carries an enforcer device which also has a precise location determination system which is accurate to the parking spot level. In step 2, the enforcer's device determines the current location and sends the location information to the RAS. This precise location information serves as vehicle identifying information (VII). The RAS uses a matching criteria to search its records of parked vehicles and their reported locations to determine if there is a parked car next to the enforcer's location that has paid for parking. The matching criteria could include the allowable distance of the car from the enforcer's location. In the embodiment with the camera, the matching criteria was simply a license plate number match. Also, as in the embodiment with the camera, the matching could be done in the RAS or in the enforcer's device if pre-fetching of the vehicle positions and payment status is done. In step 5, the RAS sends an indicator if there is a paid parked car nearby. In step 6, the enforcer's device announces if there is a paid parked vehicle next to the enforcer along with some identifying information about the car (e.g. blue Accord paid). If the enforcer notices that there is a parked vehicle for which it did not receive any announcement, then after double checking, the enforcer can issue a ticket to the parked, but unpaid vehicle.

1. A method of detecting a violation of a parking payment comprising steps of:
a) associating in real time, for each pre-registered parked vehicle, vehicle signature with a corresponding parking status, wherein vehicle signature represents at least one characteristic of the parked vehicle, and the corresponding parking status represents a status of parking payment for the parked vehicle, wherein the characteristics include characteristics of permanent type which are independent of the vehicle's parking state and characteristics that are automatically acquired by the parker's device;
b) acquiring a vehicle information of inspected vehicle, triggered by an operator's device, wherein the vehicle information represents the same characteristics as represented by the vehicle signature;
c) matching the vehicle information with a subset of the vehicle signatures that are associated to the corresponding parking status based on matching criteria, wherein said subset can be the entire group of the vehicle signatures that are associated to the corresponding parking status;
d) retrieving the parking status associated with the vehicle signature which satisfies said matching criteria;
e) signaling through said operator's device to the operator if a parking payment is made properly based on the retrieved parking status;
whereby enabling parker to pay for the parking using his own device, while completely eliminating or significantly reducing the amount of payment related information that the parker has to enter when the parker pays for the parking and at the same time transparently to the operator signaling the parking status and allowing the operator to automatically determine if the payment violation occurred.

2. The method of claim 1 further comprising steps of:
i) receiving the vehicle signature with an associated parker's device id representing a single parker account;
ii) receiving, in real time, for each parked vehicle from the parker's device at least one request, which includes the parking status with the associated parker's device id.

3. The method of claim 2, wherein the vehicle signature with the associated parker's device id is included in at least one request carried in step ii).

4. The method of claim 2 wherein at least one request is sent by the parker's device transparently to the parker.

5 The method of claim 1 wherein all the steps listed in claim 1 are carried out transparently to the operator.

6. The method of claim 1 wherein the characteristics of the parked vehicle include:
a) a license plate of the parked vehicle;
b) a position of the parked vehicle determined based on the position of the parked vehicle detected by the parker's device;
and wherein the characteristics of the inspected vehicle respectively are:
a) a license plate of the inspected vehicle;
b) a position of the inspected vehicle, determined based on the position of the moving operator that is detected using said operator's device.

7. The method of claim 6 further comprising steps of:
taking a plurality of photos by a hands free camera that is attached to the body of the moving operator; and
automatically detecting if said license plate of the inspected vehicle is in the photos; and
recognizing said license plate of the inspected vehicle.

8. The method of claim 6 further comprising steps of:
operator viewing said license plate of the inspected vehicle;
speaking said license plate of the inspected vehicle into a microphone; and
recognizing said license plate of the inspected vehicle via speech recognition system.

9. The method of claim 6 wherein said matching criteria are satisfied when said license plate of the parked vehicle is identical to said license plate of the inspected vehicle within predefined accuracy threshold.

10. The method of claim 6 wherein said matching criteria are satisfied when the position of the inspected vehicle is identical to the position of the parked vehicle within a predefined radius.

11. The method of claim 1 further comprising signaling if parking payment was made properly using at least one of the following methods:
a) via audio prompts;
b) displaying it on said operator's device.

12. The method of claim 1 further comprising steps of: associating the vehicle signature with a location of the parked vehicle; creating a subset of the vehicle signatures based on the location of said operator's device.

13. The method of claim 1 wherein said subset is located in the network or locally on said operator's device.

14. A method for determining a parker's account, a parking rate and a parking provider based on the location of the parked car comprising the steps of:
a) acquiring a location information representing a parking region of the parked vehicle such that the parking region is larger than the area of a single parking spot wherein the parking region includes one or more rate areas where each rate area has the same parking rate and the same parking provider and is represented by a parking rate id;
b) receiving said location information associated with a parker's device id representing a parker account; and
c) determining the parking rate the parker should be charged and the parking provider that should be paid based on said location information;
whereby enabling to completely eliminate or significantly reduce the amount of information the parker has to enter in order to pay for the parking, even if the parkers have a cell phone with limited or no capabilities of detecting the parking region, while still providing a universal, scalable solution to identify the parker, the rate the parker should be charged and the parking provider.

15. The method of claim 14 further comprising determining the number of digits of the rate id based on the largest number of the rate areas that can be covered by the largest parking region that could be detected due to the limitation in detection capabilities of the parker's device and the network.

16. The method of claim 14 further comprising prompting the parker to enter the rate id through his device if the parking region contains plurality of rate areas such that the rate id is sufficient to determine the parking provider and the parking rate.

17. The method of claim 14 wherein the parking region is specific enough to determine the parking rate and the parking provider.

18. The method of claim 14 further comprising updating the number of the rate areas that the parking region covers by including only the rate areas that match parking criteria.

19. A method of automatically monitoring a parking status of a parked vehicle by a parker's device transparently to the parker comprising steps of:
generating events by a parker's device indicating movement of the vehicle;
updating by said parker's device a parking status based on the generated event and a vehicle state, indicating at least when car parked and when car ended the parking;
whereby enabling of gathering of information of when, where and for how long vehicles park.

20. The method of claim 19 further comprising steps of:
detecting by a parker device that the vehicle is stopped;
generating a stop event indicating that the vehicle is stopped;
recording a first position of said parker's device when said stop event is received;
recording a second position of said parker's device after pre-defined time interval;
updating said parking status indicating that the vehicle started parking if said second position out of the pre-defined range of said first position.

21. The method of claim 20 further comprising steps of:
detecting by a parker device that the vehicle's engine is started;
generating an end event indicating that the vehicle is started;
recording a third position of said parker's device when said end event is received;
recording a forth position of said parker's device after pre-defined time interval;
updating said parking status indicating that the vehicle ends parking if said forth position out of pre-defined range of said third position.

22. The method of claim 21 further comprising steps of:
calculating a location information based on said first, second, third and forth positions;
sending said location information to said control location.
